(19) United States
(12) Patent Application Publication
(10) Pub. No.: US 2006/0287909 A1
(43) Pub. Date: Dec. 21, 2006

(54) Systems and methods for conducting due diligence

(75) Inventor: John Michael McBride, Glen Allen, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/156,662

(22) Filed: Jun. 21, 2005

(51) Int. Cl. G06Q 99/00; H04M 3/51

(52) U.S. Cl. 705/10; 705/11; 705/1

(57) ABSTRACT

Systems and method for conducting a due diligence investigation include analyzing a value of a business relationship across analytical criteria. The analytical criteria are used to objectively rate the value of the business relationship. A graphical representation, based upon the rating, also provides an objective evaluation of the value.

### DESCRIPTION OF THE INVENTION

1. Field of the Invention

The present invention relates generally to conducting due diligence assessments of a business, and, more particularly to methods and systems for providing an objective assessment of a potential business relationship with a target business.

2. Background of the Invention

Today, businesses may form a wide variety of business relationships, including an array of business partnerships, investments, acquisitions, mergers, and joint ventures. A standard approach for a business to assess the worthiness of such a business relationship with a target business is by conducting a due diligence assessment.

Typically, conducting a due diligence assessment includes creating questionnaires about the potential business relationship (e.g., assessing a target business unit), gathering information from the completed questionnaires, and, from that information, identifying risks and costs associated with an investment in the business relationship. However, this approach to due diligence is highly subjective and simplistic in how it assesses the value of a relationship or investment with the business relationship. Further, as risks from market, regulatory, and industrial influences increase, the framework and logic behind existing due diligence approaches has not improved. This may leave large gaps in the existing due diligence approaches which may fail to identify large risks present in the potential business relationship.

It is accordingly a primary object of the invention to provide an improved due diligence assessment process that objectifies the inquiry into the value of a potential business relationship and that identifies risks that previous due diligence models overlooked.

### SUMMARY OF THE INVENTION

In accordance with the invention, methods and systems are provided for assessing a value of a business relationship. For instance, the method may include generating a business case containing parameters for defining the assessment of the value; developing, based on the business case parameters, a target questionnaire defining issues associated with the business relationship, where the target questionnaire categorizes each issue according to a predetermined set of analytical business categories; determining resources to assess, respectively, the value of the business relationship with respect to each predetermined analytical business category; collecting from the resources, business information about the business relationship relevant to each issue; and rating the value with respect to each analytical business category based on the collected business information from each resource.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one of several embodiment of the invention and together with the description, serve to explain the principles of the invention. In the drawings:

FIG. 1 illustrates an exemplary system for conducting a due diligence process consistent with an exemplary embodiment of the present invention;

FIG. 2 is a flowchart illustrating an overview of a method for conducting a due diligence process consistent with an exemplary embodiment of the present invention;

FIG. 3 is a flowchart showing a method for conducting a due diligence process consistent with an exemplary embodiment of the present invention;

FIG. 4 illustrates an exemplary questionnaire used in a due diligence process consistent with an exemplary embodiment of the present invention;

FIG. 5A illustrates an exemplary analysis data table for use with a due diligence system consistent with an exemplary embodiment of the present invention; and

FIG. 5B illustrates an exemplary analysis overview table for use with a due diligence system consistent with an exemplary embodiment of the present invention.

### DESCRIPTION OF THE EMBODIMENTS

Reference will now be made in detail to exemplary embodiments of the invention, examples of which are illustrated in the accompanying drawings. The implementations set forth in the following description do not represent all implementations consistent with the claimed invention. Instead, they are merely some examples of systems and methods consistent with the invention.

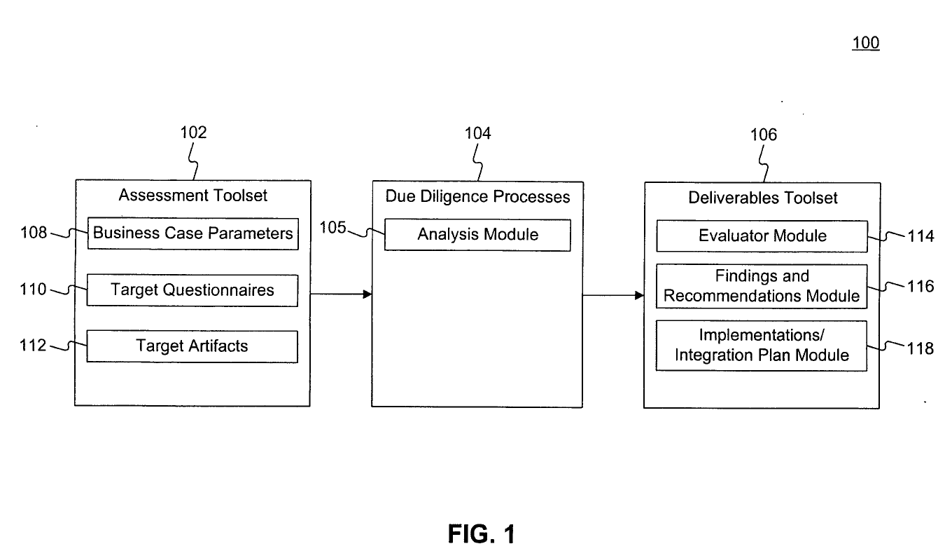

Referring now to the drawings, FIG. 1 illustrates a due diligence system 100 consistent with the present invention. System 100 includes assessment toolset 102, due diligence processes 104, and deliverables module 106. System 100 may be implemented, for example, by a PC, UNIX server, or mainframe computer for performing various functions and operations. Moreover, system 100 may be implemented, for example, by a general purpose computer or data processor selectively activated or reconfigured by a stored computer program, or may be a specially constructed computing platform for carrying-out the features and operations disclosed herein.

Assessment toolset 102 may include materials or an identification of resources for a user to begin a due diligence assessment, for example, assessing a target business. The present description describes an exemplary business relationship as assessing a target business, however, the present disclosure may be applied to assessing a value of any business relationship known in the art, including but not limited to business partnerships, investments, acquisitions, mergers, and joint ventures. In addition, the concepts of the present invention may be applied to other applications outside of business applications.

For example, system 100 may be used to investigate whether the target business is a viable business partner in a joint venture. Assessment toolset 102 may then be used to commence a due diligence investigation on the target business. For instance, as shown in FIG. 1, toolset 102 may include business case parameters 108, target questionnaires 110, and target artifacts 112 (e.g., reports, data, and diagrams). As described in more detail below, components 108, 110, and 112 may serve as tools to comprehensively analyze the target business, identify issues about the target business that may be of concern to the user, determine questions to ask the target business concerning aspects of the target's business (e.g., information technology capabilities and resources), and generate reports that present the target's information and issues that need to be addressed and resolved.

More specifically, by using parameters 108, questionnaires 110, and target artifact 112 generated in assessment toolset 102, criteria of the target business may be assessed and analyzed under due diligence processes 104. For example, system 100 may receive answers to target questionnaires 110 for evaluation according to analytical criteria implemented by processes 104. The analytical criteria may, for example, relate to the scalability, flexibility, availability, serviceability, compatibility, security, and/or innovation of the target business. These analytical criteria are explained in greater detail below. Generally, the analytical criteria may provide a user with objective qualitative standards from which to assess and analyze the target business.

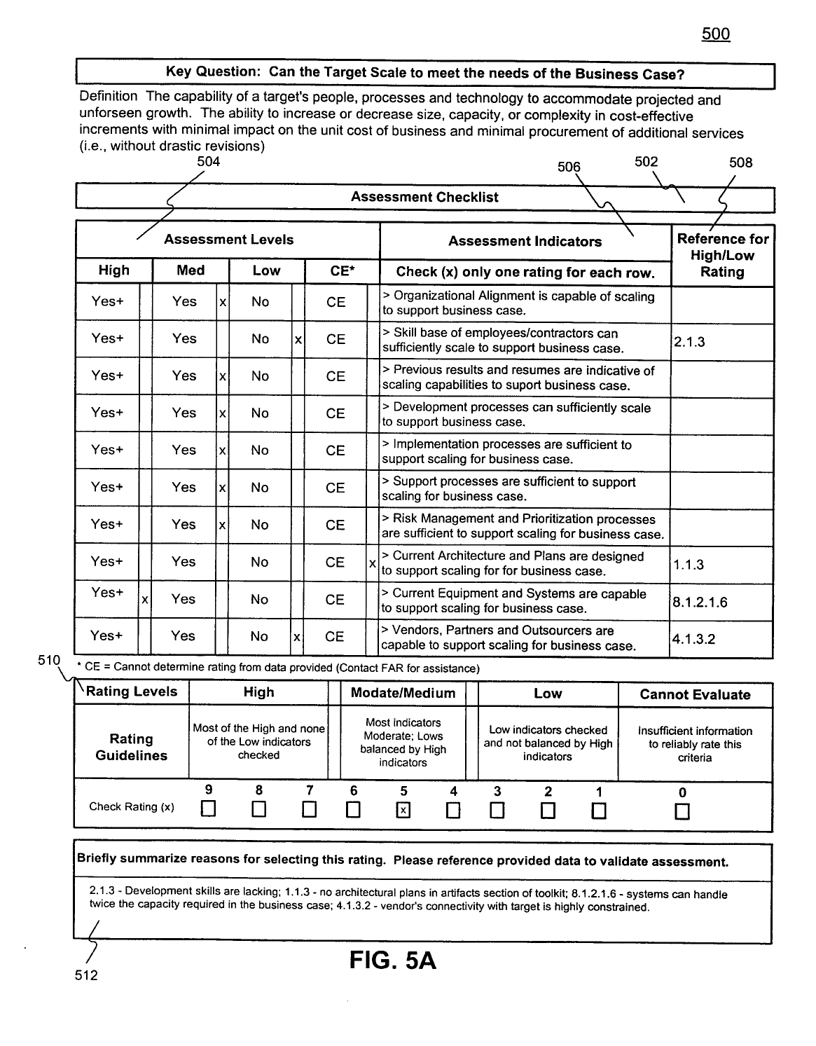

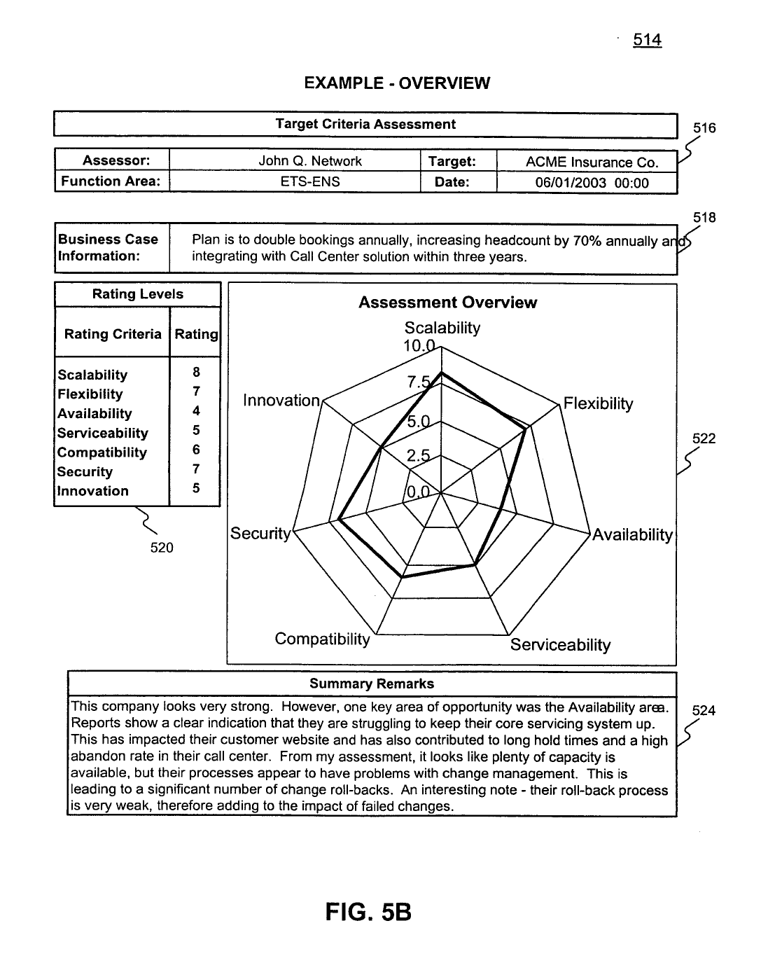

Due diligence processes 104 may include one or more analysis data tables 105 to aid in performing due diligence analysis. Analysis data tables are discussed in greater detail below with respect to analysis data table 500 in FIG. 5A.

After evaluating the target business based on the analytical criteria through due diligence processes 104, deliverable module 106 provides an objective model to determine conclusions about the target business. Module 106 may include an enhanced technology evaluation module 114, a findings and recommendations module 116, and implementation evaluations/integration module 118.

The enhanced technology evaluation module 114 may include reports on an applicability of the target business for acquisition, partnership, and/or investment over several categories. These categories may directly concern the internal technology, processes, and/or resources of the target business (e.g., the quality of the IT department of the target business) or may concern other areas of technology associated with the target business.

Findings and recommendations module 116 may generate output regarding findings about the target business and recommendations on whether to pursue a relationship or venture with the target business. For instance, module 116 may include an objective ratings system that may compare objective criteria associated with the target business with similar objective criteria associated with other business of other potential ventures.

Module 118 may be used once a decision has been made to move forward with the business venture. For instance, module 118 may generate a high level project plan for the business venture. The high level project plan may include a timeline and certain goals to be accomplished during certain periods of time. The high level project plan may also include the costs of the project, the benefits of the project, and constraints associated with the project.

As noted above, system 100 may be implemented using a central processing unit (not shown) and a data storage medium (not shown), such as, for example, implemented by a PC, workstation, network computer, server, or mainframe computer. For instance, a user may then input information (e.g., via assessment toolset 102) into the personal computer and conduct computer-aided analysis of the inputted data (e.g., via due diligence processes 104) and output information regarding the evaluation of the analysis (e.g., via base model integrations 106).

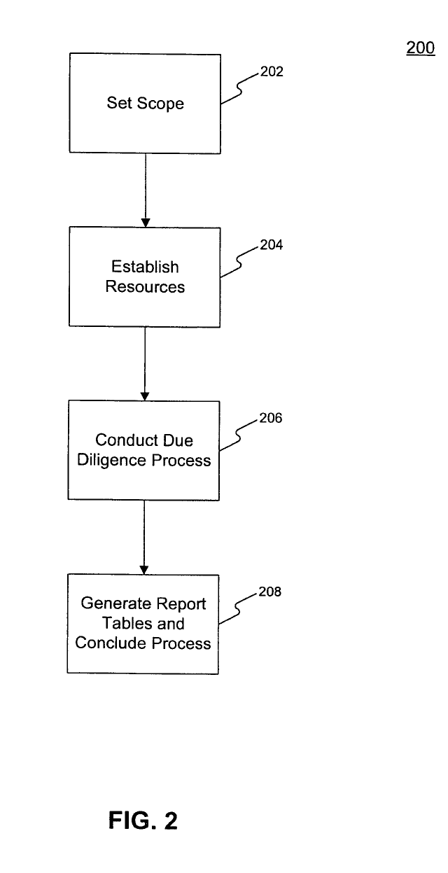

FIG. 2 is a flowchart for a method 200 illustrating an overview for conducting a due diligence process consistent with the present invention. As shown in FIG. 2, method 200 begins at stage 202 where the scope of the due diligence investigation is set. For instance, stage 202 may include the user initializing data to commence a due diligence study. This may involve prioritizing key criteria to analyze or investigate as part of the due diligence process, determining types and amounts of resources to handle each particular issue, and assembling tools and templates for each resource to use during the due diligence process. The outputs of stage 202 may then be used throughout exemplary method 200, and may include the generation of a resource responsibilities document and an initial resource plan.

Upon completing stage 202, system 100 may proceed to stage 204 where resources to conduct the due diligence process are established. Each resource (e.g., a human or computer-implemented resource) may be assigned to investigate a particular aspect of the target business. Resources, for example, may be assigned to investigate the following criteria or aspects of the target business: information technology, accounting or finances, and business market. Each resource may then establish target questionnaires 110 to use when collecting information about the target business. Further, as noted above, resources may be personnel of system 100 having specialized knowledge of the criteria or aspects of the target business in which the person will be responsible to investigate. Alternatively, resources may be implemented, for example, by a computer application program that receives input about particular criteria of the target business (e.g., financial data) and which may then automatically identify or determine the appropriate data to complete questionnaires 110 based on the inputted information.

Method 200 continues to stage 206, where resources conduct the due diligence process (e.g., via processes 104). This may include system 100 analyzing data compiled from answers to target questionnaires 110. This may also include conducting interviews with personnel for the target company and analyzing data compiled from the interviews. Once system 100 receives the compiled information, preliminary findings are determined by system 100. From stage 206, system 100 may thus output various types of data regarding the completed due diligence process.

At stage 208, exemplary method 200 may conclude. As part of this stage, system 100 may prepare (e.g., via integration models 106) due diligence reports known to those skilled in the art about the investigated aspects of the target business. Such reports may then be used to determine whether to proceed with a relationship or venture with the target business. The outputs and deliverables of stage 208 may include a recommendation and assessment document, a findings assessment, lessons learned document, and an updated toolkit.

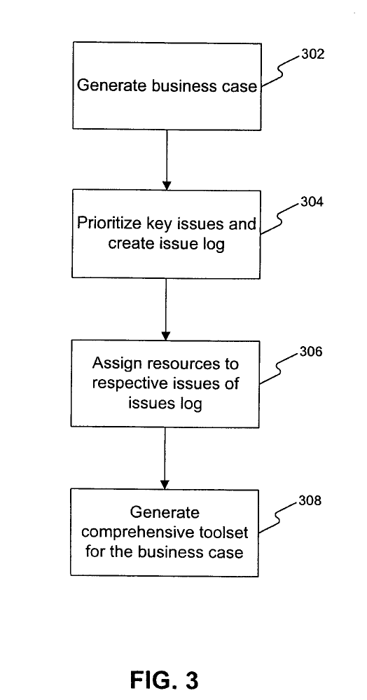

An exemplary implementation of the due diligence process implemented by stage 206 of FIG. 2 is further illustrated in FIG. 3. As shown in FIG. 3, exemplary method 300 begins at stage 302, where system 100 receives data about a potential business case concerning a target business. As well known in the art, the business case generally outlines or describes the potential business relationship or venture with the target company. The business case may, for example, be a standard form completed by a user of system 100 containing business case parameters 108.

Business case parameters 108 may provide information regarding administrative items, an overview of the business opportunity, and information regarding critical assumptions and constraints that may be present in pursuing the business relationship. The administrative parameters may include, for instance, the name of the target business, an assigned manager (e.g., personnel responsible for the due diligence process), a business officer (e.g., personnel responsible for the business after implementing the relationship or venture), a date in which the business case was created, and a target completion date. As to the business case overview parameters, these may include data reflecting the opportunity the business relationship presents, such as its end financial and market benefits. The overview section may also include objectives and critical success factors, known issues and concerns presented by the potential business relationship, and recommendations for further steps to pursue. The critical assumptions and constraints parameters may reflect an internal or external economic environment of the target business. From parameters 108, system 100 may then identify the business case objectives and any major risks that may be involved in developing the potential business relationship with the target business.

At stage 304, system 100 prioritizes key issues to be investigated as part of the due diligence process. System 100 may first identify the issues to be investigated for a particular business case using methods well known to persons of ordinary skill in the art. Once identified, system 100 may organize the key issues by business segment (e.g., the key issues associated with information technology or “IT”). System 100 may then create an issues log to document these key issues and to identify actions to be taken to resolve each issue. System 100 may implement the issues log in the form of a table (e.g., stored in computer readable memory) that includes fields for describing the issue, fields identifying a resource to which the issue is assigned, and fields for a user or assigned resource to enter data about the target business for each key issue. Each issue may be associated with an issue number, an issue status (e.g., new, open, or closed), a priority value that identifies the criticality of the issue (e.g., low, medium, or high), and an opened date for the issue (e.g., the date when the issue was raised and logged into system 100), and an actual close date (e.g., the date when the issue was resolved). Further, as described above, system 100 may generate actions to resolve each issue and store each action item in the issue log. Each action item may be a required action in response to an issue identified in the issues log.

At stage 306, system 100 may assign resources to each key issue of the issue log. System 100 may then update the issue log with information about each assigned resource. Each resource may then receive a roles and responsibilities instruction file, which instructs the resource on its investigation of the target business with respect to the issue assigned to that resource.

At stage 308, system 100 may then generate an assessment toolset 102 for the business case. Toolset 102 may include, for example, business case parameters 108, the issues log, the resolution plan, and the roles and responsibilities instruction file. Further, as noted above, toolset 102 may include target questionnaires 110 for assessment of the potential business case. As described in more detail below, questionnaires 110 may be organized using a tiered system. For instance, each questionnaire 110 may relate to a particular business segment, a functional area within the business segment, the applicability of a particular issue to the business case, a key driver, and an issue priority.

For example, considering the information technology business segment of a target business, this segment could be separated into various functional areas to be investigated by using target questionnaires 108. Exemplary functional areas for information technology may include:
1. IT Strategy—may reflect details on strategic plans of the target business, and architecture and technical plans of the target business.
2. Organizational Profile—may reflect an overview of personnel resources, skills, and organizational charts of the target business.
3. Cost profile—may reflect operating and capital budgets, and cost methodologies of the target business.
4. Contracts information—may reflect third party agreements, software/hardware agreements, and outsourcing by the target business.
5. Desktop—may reflect hardware and software maintenance for desktop computers by the target business.
6. Platforms—may reflect the extent of the distributed servers, mainframes, backups storage devices of the target business.
7. Help Desk—may reflect the target business's help desk capabilities.
8. Networks—may reflect the telecommunications, carriers, network management, design, and network support capabilities of the target business.
9. Service Delivery Management—may reflect details on service delivery processes of the target business.
10. Applications Profile—may reflect details on extent of software applications and business critical applications of the target business.
11. Security—may reflect security plans, policies, procedures, internet, remote access, and virus information.
12. Proprietary Technology—may reflect the extent of intellectual property owned by the target business.
13. Management Information Systems—may reflect data collection, storage, modeling, and reporting by the target business.
14. Human Resources—may reflect recruitment, management, payroll, and benefit policies of the target business.
15. Facilities—may reflect locations, capacities, and facility plans of the target company.
16. Supply Chain Management—may reflect supplier selection, contract management, and professional services policies and procedures of the target business.

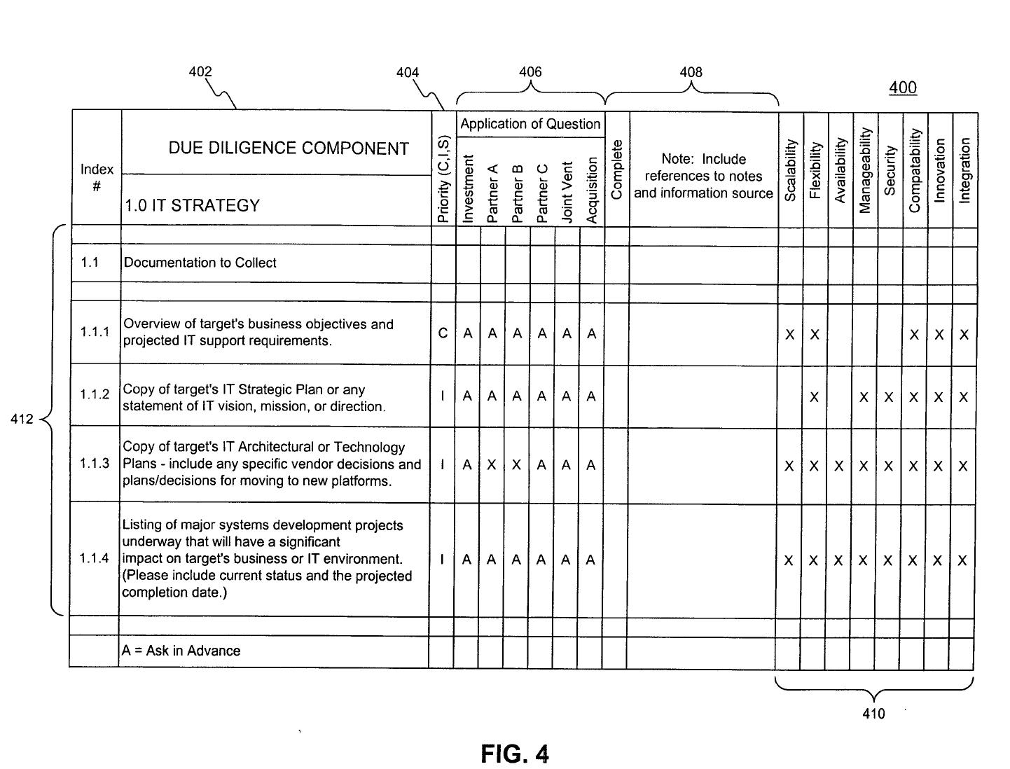

Each functional area above may be associated with one or more key issues and a target questionnaire 110. For example, FIG. 4 illustrates an exemplary questionnaire 400 for the functional area “1.0 IT Strategy” relating to information technology. As shown in FIG. 4, questionnaire 400 includes a column 402 for a due diligence component, a column 404 for an assigned priority value to each component, columns 406 for indicating the applicability of a particular issue to a business case, columns 408 for notes by users or resources, and a column 410 indicating a key driver of questionnaire 400. Questionnaire 400 may also include rows 412 indicating issues relevant to the particular functional area (e.g., in the case of FIG. 4, the functional area is “IT Strategy”), each issue identified by a corresponding issue index number. One of ordinary skill in the art would appreciate that questionnaire 400 may be adapted to apply to the other functional areas. FIG. 5 is further discussed below with relation to the other tiers in the four tier system outlined above.

Questionnaires 110 may be organized according to the key drivers. Each key driver reflects a particular analytical business category that questionnaire 400 is designed to investigate. For example, an issue of questionnaire 110 may relate to one or more of the following analytical business categories: scalability, flexibility, availability, manageability, security, compatibility, and innovation. In FIG. 4, columns 410 correspond to each analytical business category or key driver. Thus, in questionnaire 400, for example, an “X” may be placed in the relevant analytical category corresponding to each issue of a rows 412 of questionnaire 400. Thus system 100 may associate data collected in response to a particular issue with a particular analytical business category. In this way, system 100 may populate a database for each analytical business category of the target business.

Each key driver or analytical business category may relate to an aspect of the target business that is to be investigated by the due diligence process. For instance, the analytical category of “scalability” may relate to an ability of the target business to meet the scale of the business case, as well as the capability of the target business's personnel, processes, and technology to accommodate projected and unforeseen growth. “Scalability” may also reflect the target business's ability to increase or decrease its size, capacity, or complexity in cost-effective increments, with minimal impact on a per unit cost of the business and with minimal procurement of additional services from third parties.

The analytical category of “flexibility” may relate to an ability of the target business to be flexible to meet the needs of the business case. “Flexibility” may thus be defined as the ability to customize systems to support integration and new business requests. “Flexibility” may also be the target business's ability to extend or distribute its production capability in a cost-effective and timely way with minimal impact on its production systems.

The analytical category of “availability” may relate to the extent the target business has available the elements necessary to meet the business case. In other words, the “availability” may refer to the degree to which the target business's personnel, processes and technology are accessible and ready for use when needed. “Availability” may also be the quality by which the target business's personnel, processes and technology may avoid degradation or interruption due to service or parts shortages.

The analytical category of “serviceability” may relate to product quality or an ability of a target business's personnel and/or processes to provide service of a sufficient quality. “Serviceability” may also reflect the ease with which corrective or preventive maintenance can be performed on the target business's technology environment.

The analytical category of “compatibility” may relate to the capability of the target business's personnel, products, and/or processes are compatible with other systems in the marketplace. “Compatibility” may also relate to the capability of the target's technology to efficiently integrate and operate with other system in the marketplace with little to no modifications or conversions.

The analytical category of “security” may relate to the ability of the target business to ensure security to meet the needs of the business case. “Security” may also reflect measures taken by a target business to ensure privacy and protection of it's vital corporate and shared information assets.

The analytical category of “innovation” may relate to an ability of the target business to develop or maximize its technology or the extent of its existing intellectual property.

Questionnaires 110 may also be organized by their applicability to the business case. For example, each issue of questionnaire 110 may be applicable to one or more the following areas: marketing partnership, merger/acquisition, and joint venture/investment. System 100 may, for instance, mark an “X” in one or more of columns 406 of FIG. 4 to identify which area an issue is applicable.

Questionnaire 110 may also indicate a priority value (e.g., column 404) reflecting a priority given to each issue and/or question of questionnaire 400 for the particular business case. The priority value is based upon an assessment of details provided in the business case or parameters 108. The priority value may be indicated by a “C” (critical), “I” (important), or “S” (secondary). For example, FIG. 4 shows questionnaire 400 may include a column 404 indicating the priority value for each issue of rows 412.

FIG. 5A illustrates an exemplary initial analysis data table 500 for the key driver or analytical category of “scalability.” Table 500 may include assessment checklist 502, which may further include: (1) a column 504 for indicating an assessment level given by a resource for a particular assessment indicator of the particular analytical category; (2) a column 506 for identifying the assessment indicators; and (3) and a column 508 for identifying an issue index number (e.g., from a row 412 of questionnaire 400) to reference collected data supporting a particular assessment level, such as a high/low rating level. Table 500 may also include a summary ratings table 510 and a field 512 for further defining data of column 508. Although FIG. 5A shows an exemplary table for “scalability,” system 100 may use similar tables for other key drivers or analytical categories.

Analysis data table 500, or other analysis data tables, may be an example of analysis data table 105 of FIG. 1 and generated as part of due diligence processes 104.

In FIG. 5A, system 100 (e.g., an assigned resource) may complete analysis data table 500 based on information collected through questionnaires 110. For row 504, system 100 checks a box indicating either “high,” “medium,” “low,” or “CE” for each assessment indicator in row 506. “CE” indicates that system 100 cannot make a determination of the assessment level from the data provided and that further investigation may be required. If any of the assessment indicators of row 506 receive a high or low assessment level, system 100 may complete a corresponding field of column 508 with an issue index number associated with an issue of questionnaire 110 upon which the corresponding rating may be based. As noted above, field 512 may include further information explaining the basis for such rating levels.

Based upon an evaluation of all the assessment levels of column 504 for each corresponding assessment indicator of column 506, system 100 determines 510 an overall ratings level for the analytical category of the target business. The ratings level may be a score, for example, from zero (0) to nine (9), where a high score (e.g., 7 to 9) may indicate that most of the assessment levels of column 504 were high and few were low, a moderate or medium score (e.g., 4 to 6) may indicate that most assessment levels were moderate and any low levels were balanced by high levels, a low score (e.g., 1 to 3) may indicate that the assessment levels were low and few were high, and a score of zero (0) may indicate that system 100 cannot evaluate the analytical category because of insufficient information.

For example, as shown in FIG. 5A, for the analytical category of “scalability,” system 100 determines a rating of five (5) in field 510 based upon the assessment levels given in column 504 for each assessment indicator of column 506. Also as shown, system 100 may provide references in column 508 to questionnaires 110 for assessment levels of high, low, and CE. FIG. 5 further illustrates exemplary explanations in field 512 for assessment levels of column 504.

In addition, while the present disclosure describes a single data table 500, the present invention may include multiple analysis data tables from different environments of the business relationship corresponding to each subject matter expert. For example, in assessing an IT department of a target business, multiple analysis data tables may be completed for areas such as: Data Management, Technology Operations (such as networks, voice, and data center), Line of Business Systems, Corporate Information Systems, Architecture, Strategic Technologies, and Information Risk Management.

Upon completing data tables 500 for each analytical business category and/or for each environment for the subject matter experts, system 100 may generate a graphical representation of an overall rating for the target business. FIG. 5B illustrates an exemplary overview table 514 of the analytical categories investigated by the due diligence process using system 100. As shown in FIG. 5B, overview table 514 may include administrative information 516, business case information 518, rating levels 520, graphical assessment overview 522, and summary remarks 524.

Administrative information 516 may pertain to administrative items for the due diligence process of the particular target business. Business case information 518 may summarize the purpose of the business case, such as the purpose for a possible venture with the target business. Rating levels 520 summarize the overall ratings (e.g., from field 510 of data table 500) determined for each of the analytical categories (e.g., in FIG. 5B, “scalability” of the target business was an eight (8)). System 100 may further graphically display the overall ratings of the target business in an assessment overview field 522. For example, each of the seven analytical business categories may be represented by a respective corners of a seven sided polygon. System 100 may then plot the respective ratings for each of the categories and then connect the plotted positions to form a shape representative of the overall score for the target business. In exemplary embodiments, system 100 may then calculate the area of the shape plotted in field 522 to further score the result of the due diligence process. The evaluation is summarized in summary remarks 524. Specifically, based upon assessment overview 522 and the rating levels 520, the user may enter summary remarks of the potential business relationship with the target business.

Upon system 100 generating data table 500 and overview table 514, system 100 may conclude the due diligence process (e.g., stage 208 of FIG. 2). For instance, from the data collected by system 100 on the target business, system 100 may prepare a due diligence report of assessments and recommendations on the possible relationship or venture with the target business.

In addition, multiple data tables for each subject matter expert may be used to provide a comprehensive assessment consistent with the principles disclosed herein.

The foregoing description of possible implementations consistent with the present invention does not represent a assessment list of all such implementations or all variations of the implementations described. The description of only some implementations should not be construed as an intent to exclude other implementations. One of ordinary skill in the art will understand how to implement the invention in the appended claims in may other ways, using equivalents and alternatives that do not depart from the scope of the following claims.

The systems and methods disclosed herein may be embodied in various forms including, for example, a data processor, such as a computer that also includes a database. Moreover, the above-noted features and other aspects and principles of the present invention may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Systems and methods consistent with the present invention also include computer readable media that include program instruction or code for performing various computer-implemented operations based on the methods and processes of the invention. The media and program instructions may be those specially designed and constructed for the purposes of the invention, or they may be of the kind well known and available to those having skill in the computer software arts. Examples of program instructions include, for example, machine code, such as produced by a compiler, and files containing a high level code that can be executed by the computer using an interpreter.

What is claimed is:

1. A method for assessing a value of a business relationship, the method comprising:
generating a business case containing parameters for defining the assessment of the value;
developing, based on the business case parameters, a target questionnaire defining issues associated with the business relationship, where the target questionnaire categorizes each issue according to a predetermined set of analytical business categories;
determining resources to assess, respectively, the value of the business relationship with respect to each predetermined analytical business category;
collecting from the resources, business information about the business relationship relevant to each issue; and
rating the value with respect to each analytical business category based on the collected business information from each resource.

2. The method of claim 1, wherein rating the value is performed by each resource.

3. The method of claim 1, wherein developing the target questionnaire further includes:
prioritizing the issues to be assessed by each resource.

4. The method of claim 1, wherein the analytical business categories are at least one of scalability, flexibility, availability, manageability, security, compatibility, and innovation associated with the business relationship.

5. The method of claim 1, wherein the rating further includes identifying a particular issue of the target questionnaire that forms a basis of a rating.

6. The method of claim 1, further including:
developing an overall score for the target business based on the ratings of the analytical business categories.

7. The method of claim 6, wherein the overall score is displayed using a two-dimensional representation of the ratings for each analytical business category.

8. The method of claim 7, wherein the overall score is based on an area bounded by the two-dimensional representation.

9. A system for assessing a value of a business relationship, comprising:
a target questionnaire module defining issues associated with the business relationship, where each issue is categorized according to a predetermined set of analytical business categories;
an assessment module for determining resources to assess, respectively, the target business with respect to each predetermined analytical business category and for collecting from the resources, business information from the business relationship relevant to each issue; and
an integration module for rating the value with respect to each analytical business category based on the collected business information from each resource.

10. The system of claim 9, wherein the target questionnaire module prioritizes the issues to be assessed by each resource.

11. The system of claim 9, wherein the analytical business categories are at least one of scalability, flexibility, availability, manageability, security, compatibility, and innovation associated with the business relationship.

12. The system of claim 9, wherein the rating further includes identifying a particular issue of the target questionnaire that forms a basis of a rating.

13. The system of claim 9, further including:
developing an overall score for the target business based on the ratings of the analytical business categories.

14. The system of claim 13, wherein the overall score is displayed using a two-dimensional representation of the ratings for each analytical business category.

15. The system of claim 14, wherein the overall score is based on an area bounded by the two-dimensional representation.
